(19) United States
(12) Patent Application Publication
(10) Pub. No.: US 2024/0099209 A1
(43) Pub. Date: Mar. 28, 2024

(54) Stand Alone Farm System

(71) Applicant: BRICK STREET FARMS LLC, St. Petersburg, FL (US)

(72) Inventors: Bradley B Doyle, St. Petersburg, FL (US); Shannon M O'Malley, St. Petersburg, FL (US)

(21) Appl. No.: 18/252,594

(22) PCT Filed: Nov. 28, 2022
(86) PCT No.: PCT/US22/80476

§ 371 Date: May 18, 2023

Related U.S. Application Data
(60) Provisional application No. 63/255,533, filed on Oct. 14, 2021.

(51) Int. Cl. A01G 31/02

(52) U.S. Cl. CPC A01G 31/02; A01G 2031/006

(57) ABSTRACT

The invention relates to an easy-to-use system that provides an all-in-one shipping container farm that enables a user to grow 4,400-12,000 plants per month and provides the infrastructure to raise the plants from seed to harvest. The system provides an integrated system which provides nutrients, water, light and controlled atmosphere to raise the crops.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to the field of agriculture technology which utilizes a modular, containerized hydroponic growing system to grow leafy greens and culinary herbs. The invention utilizes the Internet of Things (IoT) technology to remotely control and monitor the system components which facilitates the user to analyze sensor data for business intelligence purposes.

### 2) Description of Related Art

A number of systems already exist that provide a container-based system that is capable of growing produce either hydroponically, aeroponically, or using conventionally soil matrixes. These container-based systems are limited in type or selection as well as by the size of the container interior, which is generally relatively small in scale. The current container farm implementations do not provide for a compete cycle of product, such as growing crops from seed to harvest, using only a single pump and single recirculating reservoir.

In particular there is a need for a system capable of providing a complete ecosystem dedicated to farming on a micro rather than macro level and that provides growing areas for both nursery-stage crops and mature harvesting-stage crops.

### BRIEF SUMMARY OF THE INVENTION

The instant invention in one form is directed to an easy-to-use system that provides an all-in-one shipping container farm that enables a user to grow 4,400-12,000 plants per month and provides the infrastructure to raise the plants from seed to harvest. The instant invention also provides an integrated system which provides nutrients, water, light and controlled atmosphere to raise the crops. The system is integrated into a High Cube Refrigerated Shipping Container (HCRSC), which provides an insulated container platform that provides the environment need to maintain the environmental conditions to support optimum plant growth.

The system has two distinct grow zones for the plants. The first grow zone provides a separate seed nursery that allows the user to start the plants from seeds. The second grow zone provides the growing platform that allows the user to transplant baby plants from the nursery into hollow growing channels where the plants are nourished until maturity. The system also facilitates harvesting of plants when they are ready and preparation of the growing zones for the next harvest.

The system is controlled by an integrated HCRSC controller that monitors all the environmental and safety systems. The HCRSC controller has a HCRSC controller program that oversees a number of systems integrated into the HCRSC container, such as but not limited to a water system, environmental and climate control system, and human safety controls, all of which connect to the HCRSC controller. The HCRSC controller can be monitored from an onsite control panel or remotely from a cloud application.

An advantage of the present invention is that it provides the user with a platform that provides a compact and self-contained growing platform containing all the processes needed to feed and raise crops with a simple control system that has an easy-to-use interface and cloud accessibility.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is a top cutaway view of the HCRSC container of the instant invention showing the zones and racks that support the grow channels, water distribution and HVAC system;

FIG. 2 is a distal end view of the racks looking inward from the distal wall of the HCRSC container;

FIG. 3 is a proximal end view of the equipment mounted on the interior of the proximal wall of the HCRSC container;

FIG. 4 is a distal end view of the container looking at the exterior distal wall of the HCRSC container from inside the HCRSC container;

FIG. 5 is a proximal end view of exterior of the proximal wall of the HCRSC container;

FIG. 6 is a cutaway elevation view of HCRSC container looking to the left side of the instant invention showing the grow zones and propagation (nursery) zone;

FIG. 7 is a cutaway elevation view HCRSC container looking to the right side of the instant invention showing the grow zones;

FIG. 8 is a cutaway elevation view looking to the left side of the instant invention; showing lighting and fan locations;

FIG. 9 is a cutaway elevation view looking to the right side of the instant invention showing lighting and fan locations;

FIG. 10A is a cutaway elevation view of the plumbing schematic of the HCRSC container of the instant invention;

FIG. 10B is a perspective view of the dosing loop plumbing schematic of the HCRSC container of the instant invention;

FIG. 10C is a perspective view of the fresh water plumbing schematic of the HCRSC container of the instant invention;

FIG. 10D is a perspective view of the main feed loop plumbing schematic of the HCRSC container of the instant invention;

FIG. 10E is a perspective view of the propagation loop plumbing schematic of the HCRSC container of the instant invention;

FIG. 10F is a perspective view of the plumbing sub-assemblies schematics of the HCRSC container of the instant invention;

FIG. 11 shows the HCRSC system controller of the instant invention;

FIG. 12 shows typical 12-foot rack supports of the instant invention;

FIG. 13 shows typical 8-foot rack supports of the instant invention;

FIG. 14 shows a typical power and lighting schematic of the instant invention;

FIG. 15 shows a typical Digital Input and Output (I/O) schematic of the instant invention;

FIG. 16 shows a block diagram of the control panel and the related water management control system, environment/climate control system, human safety control system, local network and cloud management system;

FIG. 17 shows a diagram of the water control management system.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The term platform system, container and HCRSC container are used interchangeably within the specification and are intended to mean a self-contained platform that provides a compact and self-contained growing platform containing all the processes needed to feed and raise crops.

The terms plant, plants, crop and crops mean any type of plant that can be cultivated in an indoor environment.

The terms control system and HCRSC controller mean an electrical/electronic system used to control or receive information from a variety of electrical and electronic devices such as switches, sensors, motor controllers, lighting controllers, fan controllers.

The term cloud-management system as used in this specification means a remote system that receives information from the control system and allows at least one user the ability to view information and input operating parameters to modify, start, stop, remotely control and monitor system components contained within the instant invention.

The term control valve as used in this specification means a device for turning off or modifying the flow rate of a fluid within a piping system.

The term nutrient film technique (NFT) is a hydroponic technique wherein a very shallow stream of water containing all the dissolved nutrients required for plant growth is re-circulated past the bare roots of plants in a watertight gully, also known as channels. The specification utilizes channels and nutrient film technique interchangeably.

Prior to a discussion of the preferred embodiment of the invention, it should be understood that the invention is a modular containerized hydroponic growing system for plants including leafy greens and culinary herbs that uses Internet of Things (IoT) technology to remotely control and monitor system components and analyze sensor data for business intelligence purposes specific to the growing of plants.

The instant invention also integrates the technology into a flexible system that has multiple grow zones for maturing plants and an integrated nursery area for starting plants from seed. This two-zone system permits seed cultivation (nursery stage crops) to occur within the same environment as the mature production (harvesting stage crops). Once the mature production is harvested, the NFT channels can be cleaned and the plants from the nursery can be transplanted to the cleaned NFT channels and raised to maturity.

The instant invention is a technological solution to provide compact food production that can benefit any organization that values fresh produce that is produced locally. It accomplishes the growing of high-quality food by utilizing a number of integrated systems built into the HCRSC container. The instant invention utilizes an HCRSC control system that supports the plant growth by controlling the hydroponic processes such as a water management control system, an environment/climate control system and lighting. The HCRSC control systems also provides the control functions for the human safety control system, a local network and a cloud management system used with the instant invention.

The ability for the instant invention to control water, nutrients, CO₂ levels, temperature and lighting means that the plants have the ideal growing conditions and therefore mature quicker, which reduces the time for a plant to reach maturity and therefore decreases the time between harvests. Simply put, this provides to the user the ability to harvest more product during any calendar year due to the reduced time needed to raise the plants to maturity.

Furthermore, as envisioned, the instant invention has many potential users including but not limited to traditional agriculture, food distribution entities, educational institutions, government and corporate entities.

These entities can include small to large businesses that value on-site production of fresh vegetables such as produce/food distributors, grocery stores, gourmet/specialty food markets and traditional farming companies that are looking for year-round production, better control over the supply chain and less reliance on weather.

Educational institutions' uses can include the ability to provide on-site production of fresh vegetables and/or an R&D facility for programs related to science, technology, and/or agriculture.

Large corporate entities could provide on-site production of fresh vegetables for direct delivery into campus food establishments.

The instant invention provides the following features in one integrated package:
a) Water management system with at least one pump, one recirculating reservoir, one dosing system for nutrients, and one dosing system for controlling pH. The system design is optimized to support the complete growing cycle and includes water filtration and water sterilization.
b) Multiple grow racks per zone with gravity drain for recirculating water to the reservoir. At least one embodiment uses six levels of grow racks.
c) Automated recirculating reservoir with a flush and refill cycle.
d) Integrated mini nanobubble generator to boost dissolved oxygen levels, reduce scale and biofilm buildup and decrease water-borne plant pathogens.
e) Integrated sand filter and UV sanitizer to further decontaminate and sanitize the water to eliminate water-borne algae and fungal spores.
f) A nursery zone capable of plugging in nutrient film technique (NFT) growing channels if user desires to setup their own nursery outside the all-in-one HCRSC container.
g) A controlled lighting package.
h) Controlled atmosphere including temperature, CO₂ and humidity.

As noted, the instant invention is a modular containerized hydroponic growing system for plants including leafy greens and culinary herbs that uses Internet of Things (IoT) technology to remotely control and monitor system components and analyze sensor data.

The instant invention is constructed from a High Cube Refrigerated Shipping Containers (HCRSC).

The HCRSC container is modified to prepare the HCRSC container for use as an environmental container suitable for supporting a high-yield grow environment (the instant invention envisions utilizing both new and used HCRSC container. The process for modifying a container is as follows (when a new container is used the removal steps are not required):
a. Remove old refrigeration unit from front or proximal wall and install a mounting system for a new commercial room climate control unit and modify the penetrations into the container for the air supply and return through the front or proximal wall of the HCRSC container.
b. Install an enclosure around the new climate control unit wall and install insulation and seal appropriately.
c. Mount the climate control unit to front or proximal wall.
d. Seal double doors on the back or distal wall and secure them so that they will not open. This can be accomplished by welding, bolting or other fastening methods. This forms a solid back or distal wall to the container. Next install a door and seal where needed so that there are no air leaks.
e. Install subfloor and water-resistant flooring material on top of the HCRSC container floor.
f Install the recirculating water reservoir tank.
g. Prepare the NFT channels by gluing all end caps and drain caps, drill holes in end caps for insertion of feed tubes.
h. Install electrical panel on exterior wall and cut an appropriate penetration in the wall to feed wiring.
i. Install all inside electrical conduit and wires, wire troughs, and junction boxes for AC line voltage, low voltage systems, and the network cabling.
j. Mount HCRSC system controller control panel on the inside of the front or proximal wall.
k. Mount custom cantilevered racking to support NFT channels and propagation/nursery flood and drain tables. These are configured into zones that include either propagation/nursery or grow zones with NFT channels. The custom racks are installed with a downhill slope at each arm. This slope allows water to move down the NFT channel, into the gutter return, then into the zone downspout, and into the reservoir return line that runs back to the recirculating reservoir.
l. Install at the end of each zone a triple/quadruple row fan on the drain side that is capable of blowing air towards the supply/feed; wire each zone's fans into junction box dedicated for row airflow fans.
m. Install ceiling fans capable of blowing air towards the entry door and plug into dedicated ceiling outlets.
n. Install main pump. In at least one embodiment, the main pump is not integrated into the HCRSC system controller as it is never turned off. The pump is never turned off because in a hydroponic system the water flows to the plant continuously to nourish the plants.
o. Install irrigation feed lines and all zone flow control valves and supply/feed manifolds to each NFT zone, install spin down filter and water flow switch directly after the main pump.
p. Install gutters on each NFT channel row and plumb to the down spout manifold.
q. Install propagation supply/feed plumbing to the six flood and drain tables off the main irrigation line. The propagation supply/feed plumbing are controlled by the HCRSC system controller during the nutrient feed process for the plants. When the nutrient feed process terminates, the valves reverse, and the tables naturally drain back to the reservoir return lines through the same supply/feed lines and into the reservoir water return line. This is done to minimize plumbing in the HCRSC container. Each flood table is constructed such that it has a high side overflow that drains into the flood table below it until it reaches the reservoir return line under the bottom row of flood tables in that grow zone. Each flood table on the bottom half of a rack must be aligned with NFT channels are on the top half, so the rack arms are mounted at a downward slope to accommodate water flow for the NFT channels.
r. Next place the six NFT channels into each row of each zone, install plumbing to each drain cap.
s. Install the recirculating waterline.
t. Install the following ports in the recirculating waterline for pH, electrical conductivity (EC), and temperature sensors, three ports for the dosing pump injection, one port for a water flow switch, at least one port for the mini nano bubble generator with pressure switch for the O₂ tank and gravity drain valve.
u. Install two penetrations in the left side of the HCRSC container and attach the necessary plumbing to connect the recirculating waterline so that the water can be diverted to the sand filter which is installed outside of the HCRSC container to facilitate back flushing.
v. Install the UV filter, nano bubble generator, 1.5-HP water chiller outside of the HCRSC container and install the appropriate plumbing to return the recirculating waterline back thru the proximal wall in the container and connect it to the recirculating water reservoir.
w. Mount the dosing pumps to the inside of the proximal wall and wire them appropriately to the control and electrical system and connect to injection ports on the recirculating line.
x. Complete the installation of the main pump and wire it appropriately to the electrical system. Install the main irrigation trunk and bulkhead suction to recirculating water reservoir.
y. Connect all water return lines into recirculating reservoir top.
z. Install incoming source water line, install the source water filter housings and associated plumbing so that it connects with the recirculating water reservoir. This enables the system to have automated water fills and provides primary filtration.
aa. Mount air pump on back wall and connect air stones thru ¼-inch air tubing, connect the air pump to an outlet and air feed tubes and air stones into buckets/tanks that will hold Nutrient A and Nutrient B formulations.
bb. Install LED growing lights in each zone above each flood tables and NFT channels in each zone (each zone forms a column of flood tables and NFT channels). Connect each light fixtures in each column to each other and connect bottom light of each zone into that zone/column's power supply. The system uses horticulture LED lights that have a specific spectrum designed for leafy green, vegetative stage production. The LED Lights are controlled using schedule rules defined in the HCRSC system controller and are based on the grower's Daily Light Integral (DLI) target. Typically, the HCRSC system controller will be programed to turn the lighting on after sundown, when electricity is cheapest, and run for between 12-18 hours depending on crop variety. The 8′ zone that shares half NFT channels and half Propagation/Nursery flood and drain tables are separated such that the lighting is controlled by HCRSC system controller separately.
cc. Install air curtain above entry door, smoke/fire alarms, fire extinguisher, lighted emergency exit sign and wire smoke/fire alarm to the control panel.
dd. Mount the CO₂ solenoid on wall, connect feed line to food grade CO₂ bottle and connect to control solenoid. Install CO₂ distribution tubing and run it along the ceiling in the middle aisle to create CO₂ distribution system.

The next step is to install the climate control system. To function properly as a self-contained growing chamber the HCRSC container must have a climate control system that provides cooling, heating and humidity control of the HCRSC container. The system is attached to thermostats and humidity sensors that are integrated into the HCRSC container control system. The system must also have the ability to introduce fresh air into the grow chamber. This feature needs to filter the air so that outside spores and other airborne plant pathogens are eliminated from the introduced air. Therefore, a HEPA-rated filter should be incorporated into the climate control system to filter the air and prevent the introduction of outside spores and other airborne plant pathogens.

After installation of the climate control system, the next step is to is to connect the climate control system to the HCRSC system controller. The HCRSC system controller is connected to the climate sensors such as temperature and humidity of the air. The HCRSC system controller is programed with schedules and rules that are used to manage the cooling, heating and humidity based on either the schedules or information received from the climate sensors.

The next step is to connect the CO₂ system which is typically connected to compressed CO₂ supply which supplies the CO₂. The CO₂ system controls the CO₂ content of the HCRSC container to optimize the plant growth. The HCRSC system controller is connected to the CO₂ system and the HCRSC system controller monitors and controls the CO₂ content of the air in the HCRSC container by adding CO₂ to the air in the HCRSC container. It utilizes both information from the CO₂ sensors and schedule information to adjust the CO₂ levels in the HCRSC container to ensure that the levels are optimum to promote plant growth. The HCRSC system controller program maintains the desired ppm CO₂ content of the air in the HCRSC container. The instant invention also envisions that the CO₂ supply can be either CO₂ cylinders or a separate mycelium type CO₂ production system.

The control of the CO₂ content of the air in the HCRSC container is accomplished by operating the CO₂ valve attached to the tubing previously installed and dosing the HCRSC container with CO₂ until the desired amount of CO₂ is sensed by the CO₂ sensor and the HCRSC system controller turns off the system. The preferred amount of CO₂ in the HCRSC container depends on the plants being grown, but the recommended normal target for the CO₂ level is two to three times the average CO₂ level of ambient atmosphere, which is approximately 400 ppm.

The next step is to install an air flow system. The air flow system serves three functions. The first function is to transport treated air from the climate control unit air supply to the opposite end of the HCRSC container. This is accomplished by a set of fans installed in the HCRSC container. These fans are connected to the HCRSC system controller so that it can control the delivery of treated air. The second function is to transport air back to climate control unit air return at the opposite end of the HCRSC container. This is accomplished by a second set of fans installed in the HCRSC container. These fans are connected to the HCRSC system controller so that it can control the delivery of treated air. These two airflow control systems can alternatively be replaced with conventional air supply plenum and return plenum with integrated fans.

The third function is accomplished by the row fans that are mounted on each row or NFT channels in the NFT zones to provide humidity reducing air flow across the top of the crop canopy. In at least one embodiment, the row fans are not connected to the HCRSC system controller and are manually operated.

This completes the air flow system control system.

Further discussion is needed to provide a complete disclosure of the water dosing, cleansing & irrigation control systems. This system is comprised of a number of devices including a reservoir, motorized valves, pressure sensors, flow sensors, pH sensors, electrical conductivity (EC) sensors, water temperature sensors, dissolved oxygen sensor, water chiller, nano bubble generator, UV light sanitizer, and filtration system that are all connected to the HCRSC system controller and monitored by the HCRSC system controller program.

Water temperature is an important variable and warrants further discussion. The system monitors the temperature in the water recirculating line to identify when the water chiller is not operating properly. Proper water temperature is critical for plant health and should be keep at 70 degrees or below to reduce the potential for root pathogen infection, which increases as water temperature increases.

The HCRSC system controller controls the water supply for the recirculating nutrient reservoir flush and fill system. The HCRSC system controller uses a pressure transducer to determine when to open and close the fill valve. However, a fluid level sensor could also be used, and these include both float type sensors or ultrasonic sensors. The pressure transducer is scaled in the HCRSC system controller program based on reservoir dimensions to calculate water level based the sensor's pressure from the water in the reservoir. The pressure sensor rules are defined in HCRSC system controller program and they are designed to fill the reservoir at a defined low water level setpoint and stop filling once it has reached the defined high level setpoint.

The HCRSC system controller program controls the distribution of water to the recirculating line and water supply/feed manifolds. The HCRSC system controller program also controls a number of functions related to the water system and monitors system components to prevent damage to devices such as the pump. The HCRSC system controller program controls the recirculating line, which controls the dosing, chilling, cleansing and nano bubble injection of the water. The HCRSC system controller program is configured to initiate water reservoir flush and refill to facilitate nutrient water replenishment. The flushing algorithm flushes the systems to ensure they are clean to minimize the possibility of pathogens in the water system and reset the balance of macro and micronutrients levels in the recirculating feed water.

The HCRSC system controller program also controls the reservoir fill valve and as such controls when the system refills the reservoir with water. The HCRSC system controller program also verifies that the pump is primed so as to prevent pump damage, it verifies water flow and it verifies that the dosing system is activated to ensure that pH and electrical conductivity (EC) setpoints are within programed ranges set in the HCRSC system controller program. Any sensor readings indicating water levels or flow rate too high or too low triggers digital alarm by the HCRSC system.

The water cleansing control system is used to control the cleanliness of the water. This is directly related to levels (ppm) of dissolved oxygen that is measurable in the water. The instant invention utilizes nano bubble technology to remove pathogens from the water. Nano bubbles are small and dense bubbles of O₂ that are injected into the water. The water becomes super saturated with O₂ molecules. The oxygen nanobubbles combine with elevated dissolved oxygen (DO) to improve water quality, increase nutrient absorption, and mitigate disease. Nanobubble technology delivers shorter cultivation times and increased crop yields. The water quality benefits of being super saturated with O₂ include reduction of biofilm and scale buildup and destruction of water borne pathogens such a Pythium and Fusarium, which are common causes of root rot diseases in plants. The instant invention utilizes nanobubble technology and injects the nanobubbles into the recirculating water line that handles nutrient dosing, pH control, UV light sterilization and chilling. The nanobubble device is connected to an O₂ tank with a pressure switch or an O2 generator, which eliminates the need for continued monitoring and replacement of bottled O2. The pressure switch is connected to the to the HCRSC system controller program and the pressure switch is activated when the O₂ tank pressure switch indicates insufficient O₂. If this occurs, the HCRSC system controller program triggers an alarm. The HCRSC system controller program also monitors the water recirculating line water flow switch that indicates whether there is insufficient water flow. If there is insufficient water flow, the HCRSC system controller program disables nutrient and ph dosing, opens the gravity drain valve connected to nanobubble generator, turns off the UV sterilization light and the HCRSC system controller program triggers a digital alarm.

The recirculating filter system which is part of the recirculating line water has a sediment filter and an associated UV light sterilizer. The associated UV light sterilizes the water after sediment filtration to eliminate the threat to the plants from pathogens. The system filter can be either a sand filter or a cartridge filter. The UV sterilization device is controlled by the HCRSC system controller program.

The recirculating water system also has a water dosing control system to control the additives to the recirculating water. The additives include Nutrient A, Nutrient B, pH UP or DOWN of the water. The Nutrient A and Nutrient B dosing allow the user to provide nutrients to the plants. The nutrients provided depend on the crop being raised. Typical nutrients utilized in a hydroponic system are macronutrients and micronutrients that address the three nutrients that every plant needs, namely nitrogen, phosphorus, and potassium. The instant invention uses peristaltic dosing pumps connected to the HCRSC system controller. The peristaltic dosing pumps are controlled by the HCRSC system controller program to supply the Nutrient A, Nutrient B, or the appropriate pH control medium to the water. There is at least one mixing chamber installed after the dosing Nutrient A dosing port in the recirculating water line to ensure that the mixing of the additive with recirculating water is achieved. The use of a mixing chamber ensures precipitation does not occur when dosing different nutrient parts which can lead to forming of solids. The formation of solids makes the nutrients unavailable for plant root uptake.

NFT zones water flow control is implemented such that the HCRSC system controller program can adjust the flow rate using the flow rate valves and can actuate the clean out valves to clean out debris that has settled to the bottom of each zone's main supply/feed line.

The instant invention provides for a Nursery/Propagation Zones Water Flow Control controlled by the HCRSC system controller program. The nursery/propagation flood and drain tables are filled from the main water irrigation supply/feed line that recirculates from the water reservoirs to the NFT channels in the NFT zones. The frequency and duration of application is controlled by a schedule entered into the HCRSC system controller program, which activates valves to flood the nursery/propagation flood and drain tables. The nursery/propagation flood and drain tables can be drained by the HCRSC system controller program by activating a drain valve connected to the HCRSC system controller.

Another critical system incorporated into the instant invention is the water return control system, which has three main components:
1) row gutters;
2) zone downspout with Y junctions for the gutters to plug into; and
3) water return lines that run the length of all NFT channel zones back to the recirculating water reservoir.

The instant invention also has numerous human safety features installed and configured into HCRSC system controller program which include:
i. High CO₂ audible alarm with defined HCRSC system controller program alert rules.
ii. High CO₂ automated ventilation with define HCRSC system controller program alert rules.
iii. Code compliant Fire/Smoke+CO audible alarm with define HCRSC system controller program alert rules.
iv. Accessible fire extinguisher mounted on wall in the event of a fire.
v. Emergency battery powered lighted Exit Sign in the event of a power outage.

The following is a listing of equipment integrated into the instant invention:

Climate Control Systems (*Control System
Integrated)

| | |
|---|---|
| 1. | * 5-Ton HVAC (AC, Dehumidification, Ventilation) |
| 2. | *CO₂ Solenoid with exchangeable 50 Lb Bottled |
| | CO2 tanks and holed ¼″ tubing across the length |
| | of the inside ceiling |
| 3. | *Main (NFT Finishing) Lights (5 Zones) with 10″ |
| | canopy from light to top of growing plug |
| 4. | *Nursery/Propagation Lights (1 Zone) with 8″ |
| | canopy from light to top of seedling trays/plugs |
| 5. | *Climate Sensor (Air Temp, Relative Humidity, |
| | and CO2) mounted hanging from ceiling near front |
| | of the room/entry door |
| 6. | Redundant Backup Thermostat |
| 7. | Optional Secondary/Front Dehumidifier |
| 8. | Canopy Triple Rows Fans (33, 1 per NFT Finishing |
| | Row) |
| 9. | Ceiling Circulation Fans (2) moving air from |
| | back to the front of the room |
| 10. | Floor Circulation Fans (2) moving air from |
| | front to back of the room |
| 11. | Entry door 30″ air curtain triggered when door |
| | opens |

Water Dosing, Cleansing & Irrigation Control
Systems (*Control System Integrated)

| | |
|---|---|
| 12. | *Propagation Feed motorized ball valve |
| | (normally closed) |
| 13. | *Propagation Drain motorized ball valve |
| | (normally open) |
| 14. | *Reservoir Fill motorized ball valve (normally |
| | closed) |
| 15. | *Reservoir Flush motorized ball valve (normally |
| | closed) |
| 16. | *Water Flow Switch for Main Pump Irrigation |
| | Feed Trunk |
| 17. | *Water Flow Switch for Dosing-Nano |
| | Bubbler-Sand Filter-Chiller-UV Filter |
| | Recirculating line |
| 18. | *Recirculating line Mini Nano Bubbler flush |
| | valve |
| 19. | *Stenner Peristaltic 85 gallons per day |
| | Dosing Pumps (3 - A Base, B Base, pH Down) |
| 20. | *Reservoir Temperature sensor |
| 21. | *Reservoir pH sensor |
| 22. | *Reservoir EC (nutrient level) sensor |
| 23. | *Reservoir Water Level sensor |
| 24. | Recirculating line Mini Nano Bubble Generator |
| 25. | Recirculating line UV filter rated for up to |
| | 15 gallons per minute |
| 26. | Recirculating line Sand Filter upstream from |
| | UV filter |
| 27. | Inside Reservoir Fill Shut Off Ball Valve (1) |
| 28. | Incoming Source Water filters and housing for |
| | 10″ × 2.5″ cartridges (2 - Sediment 100-micron, Carbon) |
| 29. | 1.5 HP Aqua Culture Rated Main Water Pump |
| 30. | Nutrient Tanks with micro tubing Sediment Filters |
| | (2 - A Stock Nutrient, B Stock Nutrient) |
| 31. | Reservoir & Nutrient Tanks Aerator (Air/oxygen) |
| | Air Pump |
| 32. | 1.5 HP Outdoor Water Chiller w/Inside Thermostat |
| 33. | NFT Finishing Zones Feed line 2″ Spin Down |
| | filter (1) |
| 34. | Recirculation line Dosing Mixing Chamber (1) |
| | between Nutrient A and B injection points |
| 35. | Main Irrigation Feed Trunk Flow Rate Ball Valve |
| | (1) with return to reservoir line |
| 36. | NFT Finishing Zones Flow Rate Ball Valves (6) |
| 37. | NFT Finishing Zones Row Level Flow Rate Ball Valves |
| | (33) |
| 38. | NFT Finishing Zones removeable Feed Manifold (33) |
| 39. | Custom Cantilevered Racking for 5 × 12′ NFT Finishing |
| | Zones and 1 × 8′ Half NFT Finishing Zone, Half Nursery Zone |
| 40. | Nursery Flood & Drain tables (6) each with flow rate |
| | control ball valves (6) and overflow spouts that drain to |
| | the table below until reservoir return line is reached |
| | under bottom row |

Human Life Safety (*Control System Integrated)

| | |
|---|---|
| 41. | *Audible siren integrated to HCRSC system controller |
| | digital alerts (High CO2) |
| 42. | *Audible Smoke/Fire + CO alarms integrated to HCRSC |
| | system controller digital alerts |
| 43. | Lighted Exit Signs with Battery powered emergency |
| | lighting |
| 44. | Wall mounted fire extinguisher |

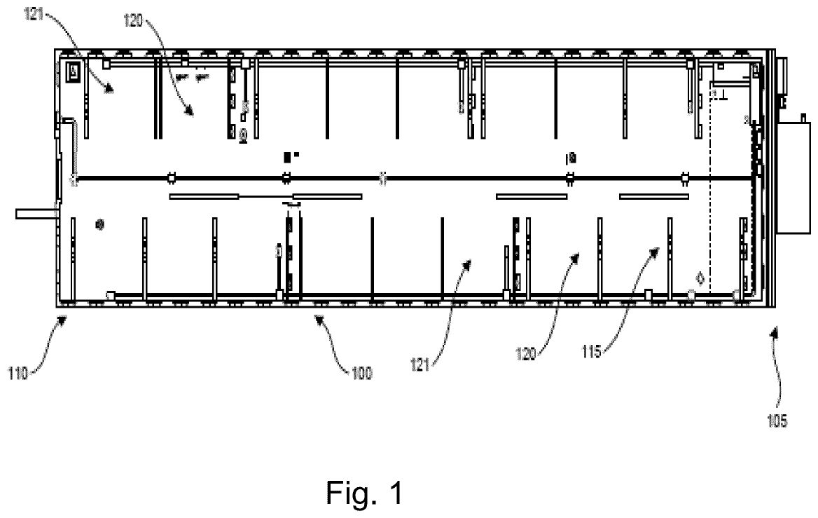

Referring now to FIG. 1-17, and more particularly FIG. 1, a top cutaway view of the HCRSC container 100 of the instant invention shows the racks that support the grow channels, water distribution and HVAV system. Distal end 110 and proximal end 105 are shown as well as a Nursery/Propagation Zone 115 and typical Growing Zone 121 with NFT channels 120 (only two identified for clarity).

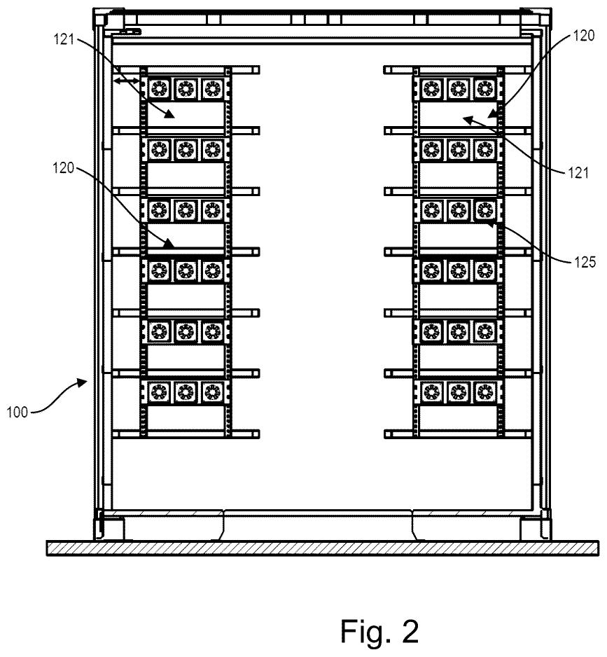

FIG. 2 is a distal end view of the racks looking inward from the distal wall of the HCRSC container 100. The row fans 125 are shown in each shelf of a typical column forming a typical Growing Zone 121 with NFT channels 120 (only two identified for clarity). The row fans 125 are mounted on each row to provide humidity reducing air flow across the top of the crop canopy.

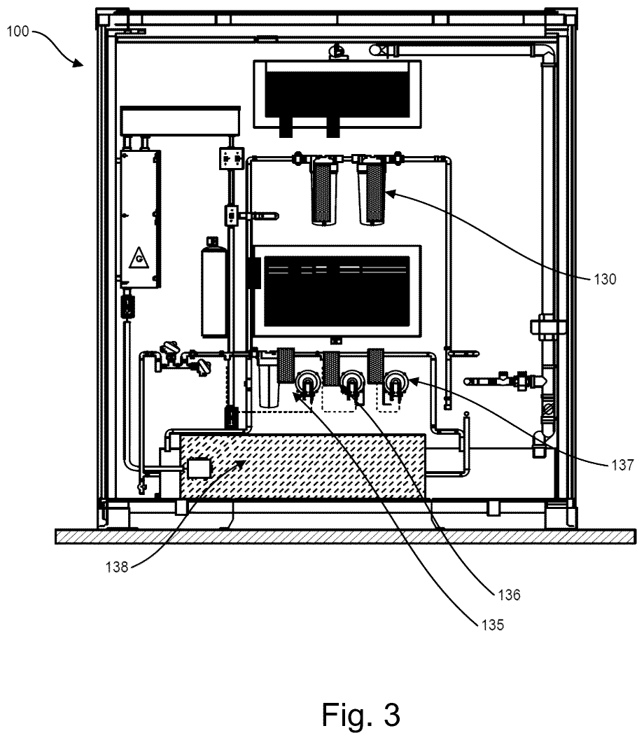

FIG. 3 is a proximal end view of the equipment mounted on the interior of the proximal wall of the HCRSC container 100. The source water filter housings 130, reservoir 138, peristaltic dosing pumps 135, 136 and 137 are shown.

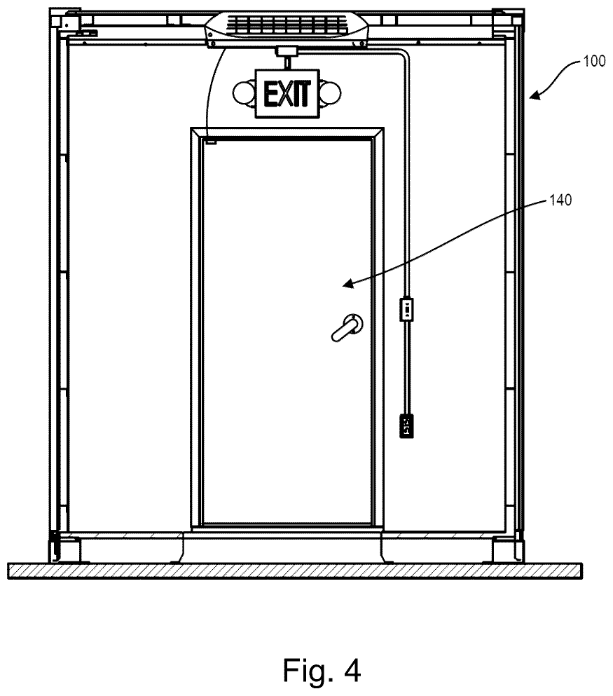

FIG. 4 is a proximal end view of the container looking at the exterior proximal wall of the HCRSC container 100 from inside the HCRSC container 100. The door 140 is shown.

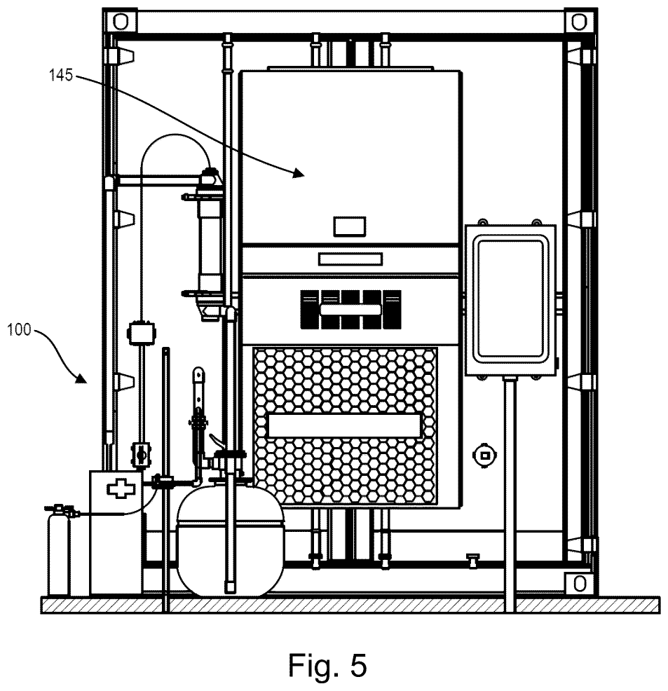

FIG. 5 is a distal end view of the exterior of the distal wall of the HCRSC container 100 showing HVAC system 145.

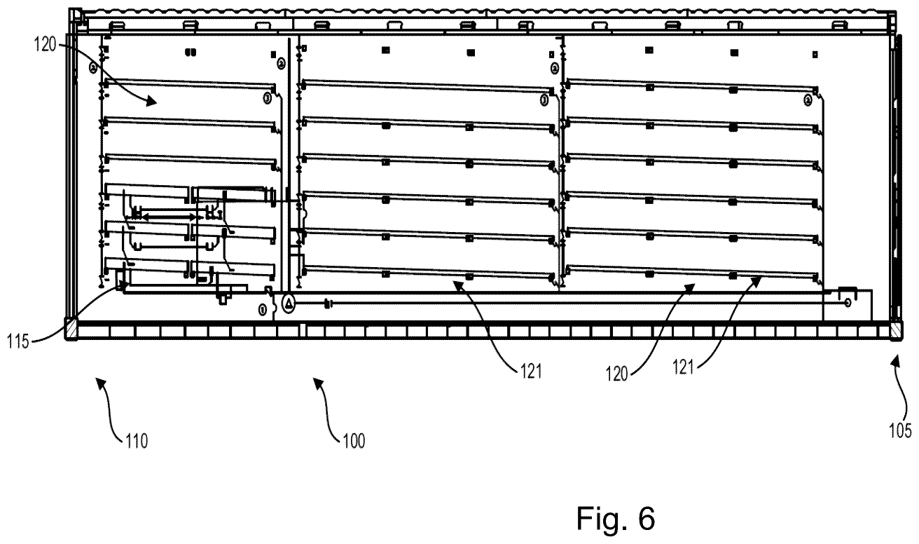

FIG. 6 is a cutaway elevation view of HCRSC container 100 looking to the left side of the instant invention showing the HCRSC container 100 of the instant invention, distal end 110 and proximal end 105, grow zones 121 with NFT channels 120 (only two identified for clarity) and propagation (nursery) zone 115.

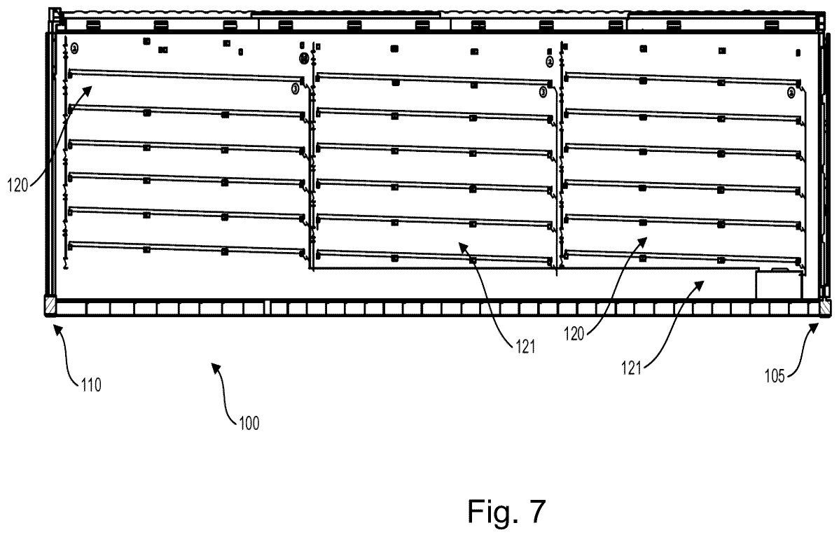

FIG. 7 is a cutaway elevation view of HCRSC container 100 looking to the right side of the instant invention showing HCRSC container 100 of the instant invention, distal end 110 and proximal end 105, grow zones 121 with NFT channels 120 (only two identified for clarity).

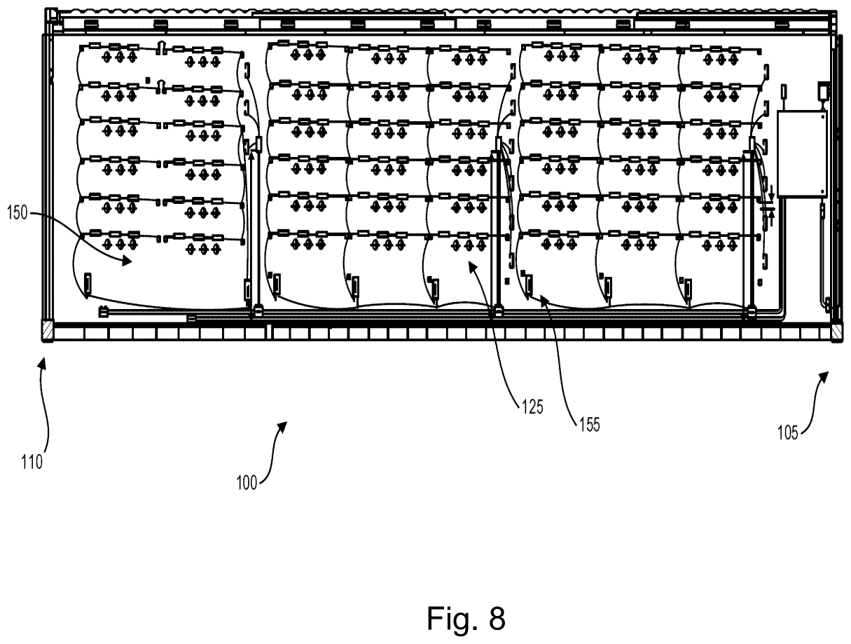

FIG. 8 is a cutaway elevation view looking to the left side of the instant invention showing HCRSC container 100, distal end 110 and proximal end 105, typical lighting 150 and lighting power supply/ballast 155, and typical row fans 125 also shown in FIG. 2. The lighting 150 comprises 6×3 bar light fixtures daisy chain straight down to 1 power supply/ballast. Power supplies in each zone are daisy chain together for a single tie into that zone's lighting circuit junction box.

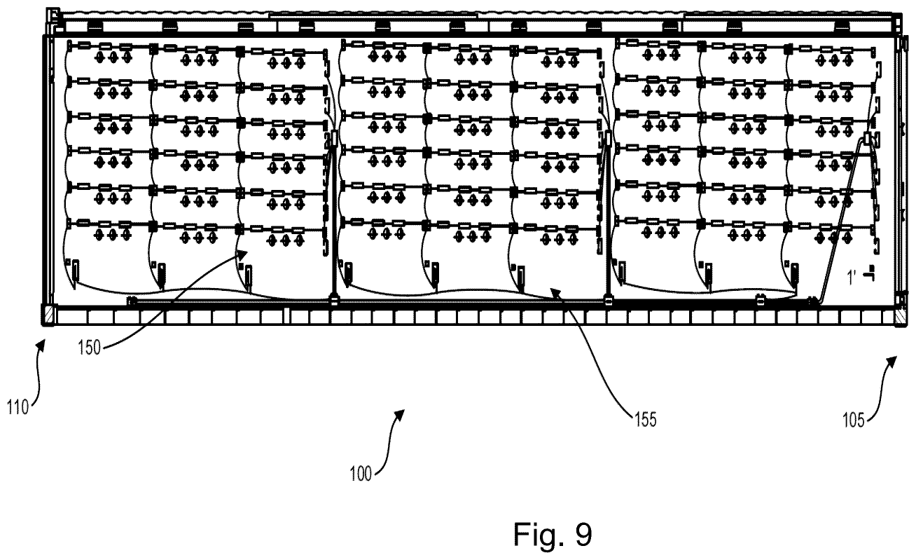

FIG. 9 is a cutaway elevation view looking to the left side of the instant invention showing HCRSC container 100, distal end 110 and proximal end 105, typical lighting 150 and lighting power supply/ballast 155, and typical row fans 125 also shown in FIG. 2. The lighting 150 comprises 6×3 bar light fixtures daisy chain straight down to 1 power supply/ballast. Power supplies in each zone are daisy chain together for a single tie into that zone's lighting circuit junction box.

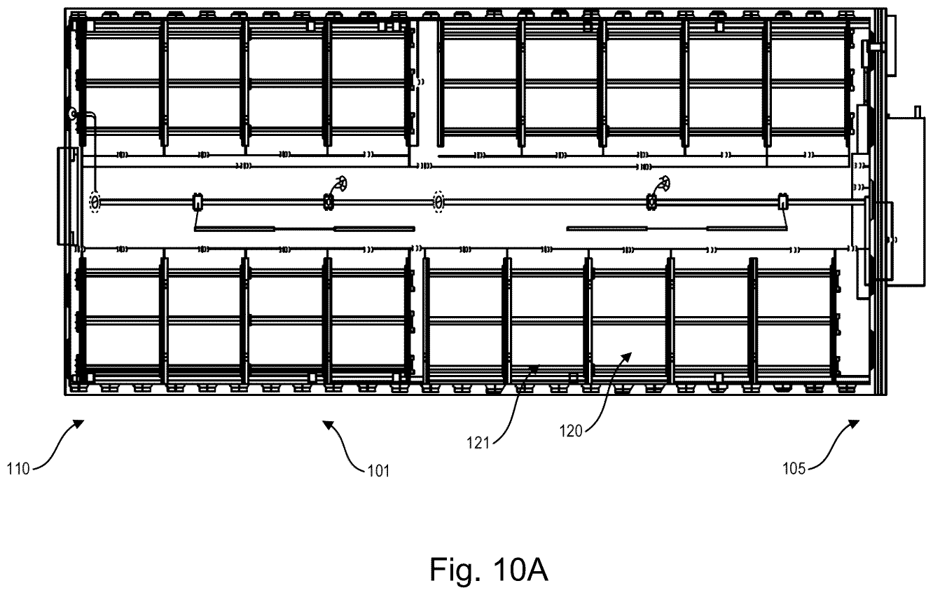

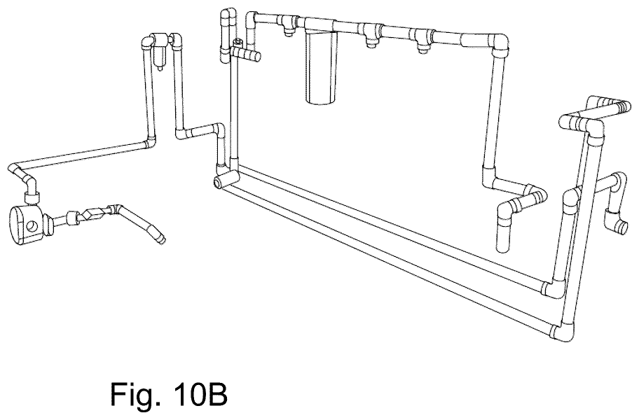

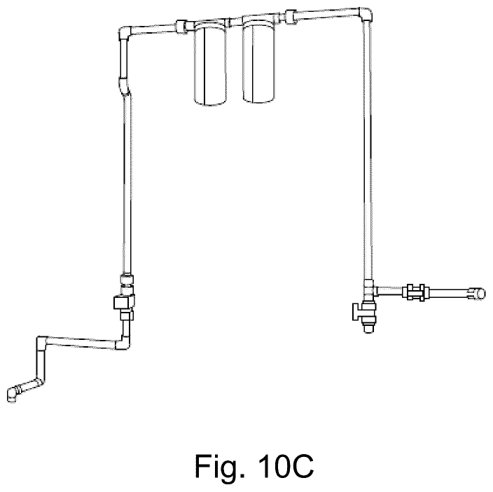

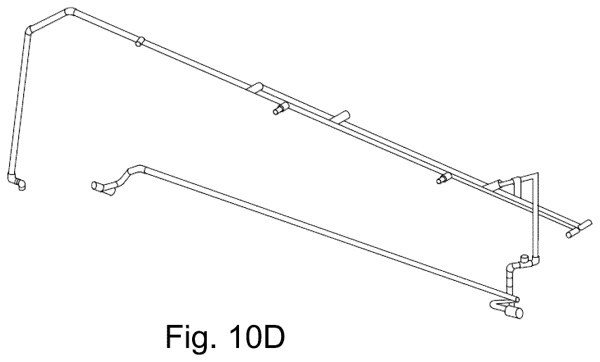

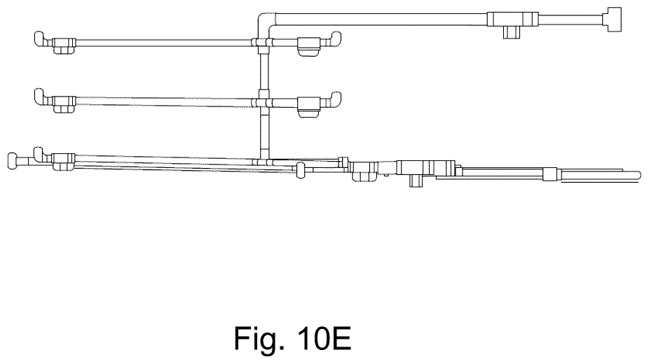

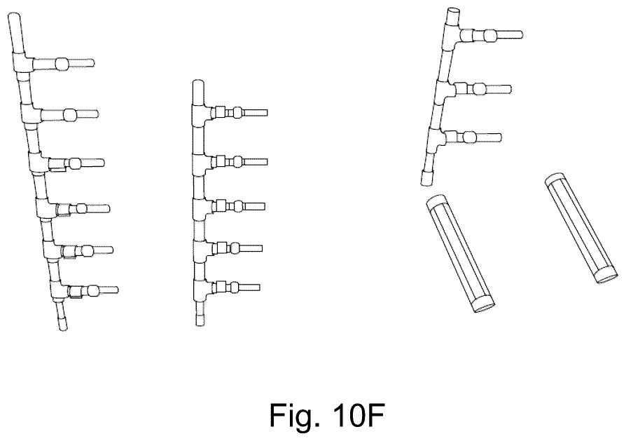

FIG. 10A shows the plumbing schematic of the HCRSC container of the instant invention.

FIG. 10B shows the dosing loop plumbing schematic of the HCRSC container of the instant invention.

FIG. 10C shows the fresh water plumbing schematic of the HCRSC container of the instant invention.

FIG. 10D shows the main feed loop plumbing schematic of the HCRSC container of the instant invention.

FIG. 10E shows the propagation loop plumbing schematic of the HCRSC container of the instant invention.

FIG. 10F shows the plumbing sub-assemblies schematics of the HCRSC container of the instant invention.

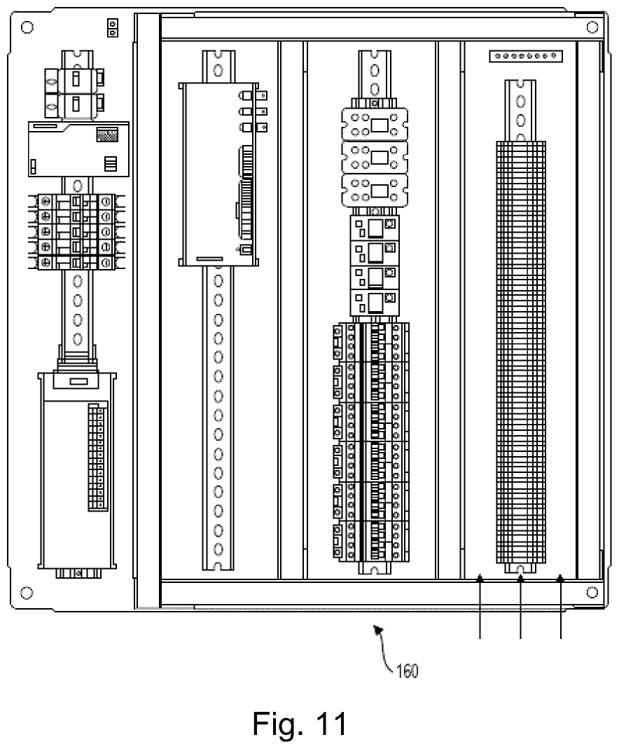

FIG. 11 shows the HCRSC system controller 160 of the instant invention.

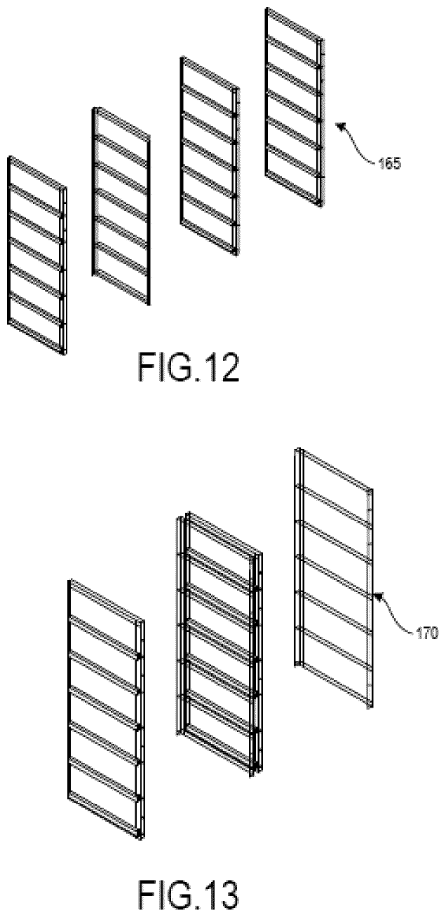

FIG. 12 shows typical 12-foot rack supports 165 of the instant invention.

FIG. 13 shows typical 8-foot rack supports 170 of the instant invention.

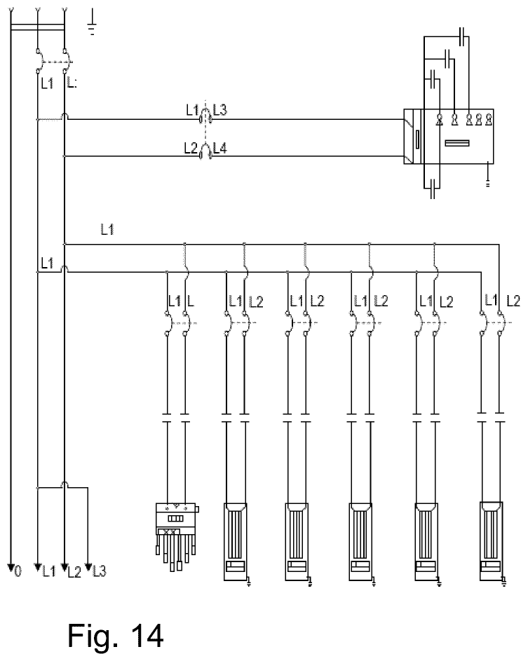

FIG. 14 shows a typical power and lighting schematic of the instant invention.

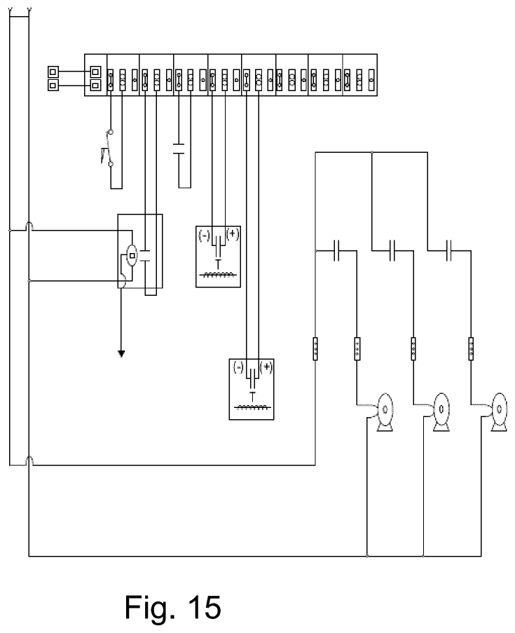

FIG. 15 shows a typical Digital Input and Output (I/O) schematic of the instant invention.

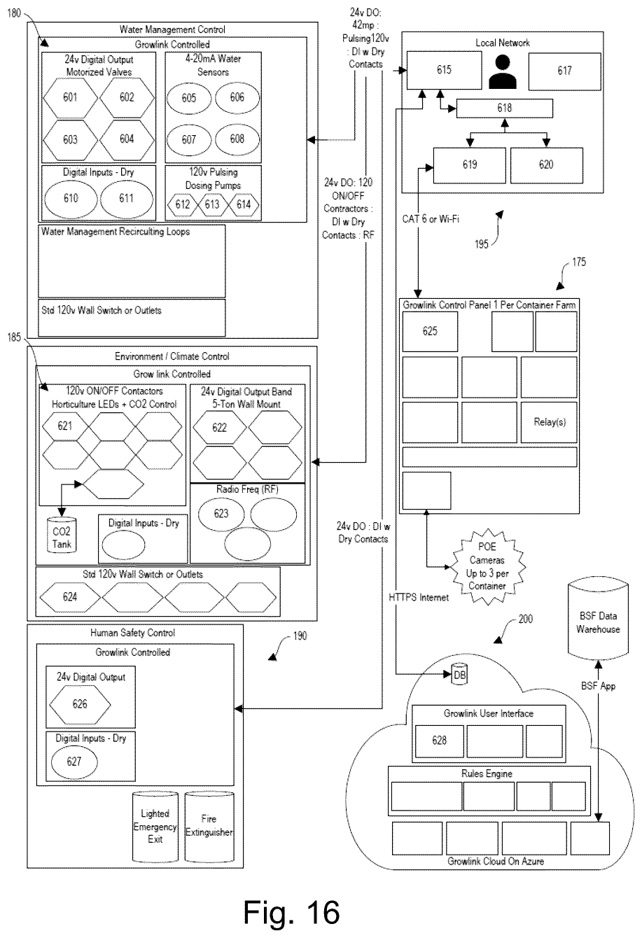

FIG. 16 shows a block diagram of the define HCRSC system controller 175 and the related water management control system 180, environment/climate control system 185, human safety control system 190, local network 195 and cloud management system 200.

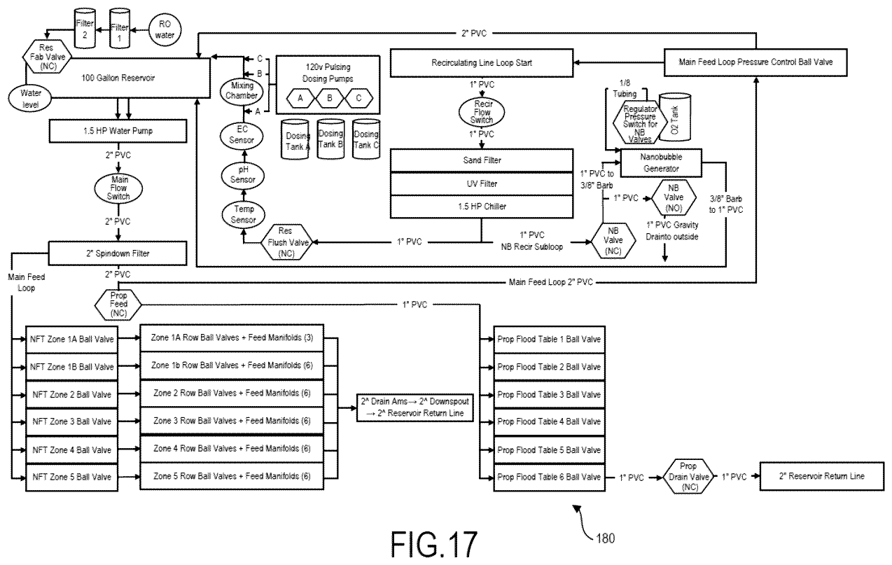

FIG. 17 shows a block diagram of the water management control system 180.

Though measurements of components of the instant invention may be provided in the accompanying figures, these measurements are non-limiting examples of potential measurements various embodiments may employ. It should be understood that the measurements may vary across alternate embodiments.

In some embodiments, the system, method or methods described above may be executed or carried out by a computing system including a tangible computer-readable storage medium, also described herein as a storage machine, that holds machine-readable instructions executable by a logic machine such as a processor or programmable control device to provide, implement, perform, and/or enact the above described methods, processes and/or tasks. When such methods and processes are implemented, the state of the storage machine may be changed to hold different data. For example, the storage machine may include memory devices such as various hard disk drives, CD, flash drives, cloud storage, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, game controllers, video camera, camera, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. (canceled)

2. A single pod grow facility comprising of:
a. at least one NFT system and said at least one NFT system having at least one NFT zone and said at least one NFT zone having irrigation feed lines;
b. a nursery/propagation zone;
c. a growing zone;
d. a nano bubble generator system;
e. a water management control system comprising a recirculating reservoir;
f. an environment/climate control system;
g. a human safety control system;
h. a grow light system;
i. a system controller;
j. a local network; and
k. a cloud management system.

3. The single pod grow facility of claim 2 wherein said water management control system having said recirculating reservoir has a pump.

4. The single pod grow facility of claim 2 wherein said nano bubble generator system injects water with high levels of dissolved oxygen into said recirculating reservoir each time said recirculating reservoir is filled.

5. The single pod grow facility of claim 2 wherein said NFT system comprises of said at least one NFT zone and said one NFT zone having at least one NFT channel and propagation/nursery flood and drain tables.

6. The single pod grow facility of claim 2 wherein said NFT system has irrigation feed lines and said at least one NFT zone having a flow control valves and a supply/feed manifolds to each NFT zone.

7. The single pod grow facility of claim 2 wherein said water management control system comprises a UV filter and a nano bubble generator.

8. The single pod grow facility of claim 2 wherein said grow light system comprises horticulture LED lights.

9. The single pod grow facility of claim 2 wherein said environment/climate control system comprise a cooling device, a heating device and humidity control device.

10. The single pod grow facility of claim 2 wherein said local network and said cloud management system enable said system controller to be monitored from an onsite panel or remotely from said cloud application.
